(19) United States
(12) Patent Application Publication
(10) Pub. No.: US 2024/0246848 A1
(43) Pub. Date: Jul. 25, 2024

(54) SYSTEM FOR DRYING SLUDGE AS WELL AS SLUDGE TURNER

(71) Applicant: HUBER SE, Berching (DE)

(72) Inventors: Andre GROSSER, Neumarkt (DE); Simon ABT, Thalmaessing (DE)

(73) Assignee: HUBER SE, Berching (DE)

(21) Appl. No.: 18/417,635

(22) Filed: Jan. 19, 2024

(30) Foreign Application Priority Data
Jan. 23, 2023 (DE) 10 2023 101 567.2

(51) Int. Cl. C02F 11/121; C02F 11/131

(52) U.S. Cl. CPC C02F 11/121; C02F 11/131; C02F 2201/002; C02F 2303/06

(57) ABSTRACT

A system (1) for drying sludge (2) comprises a drying surface (4) to accommodate the sludge (2) as well as a moveable sludge turner (3) as well as two travel paths (5.1, 5.2) that extend at least partially on opposite longitudinal sides (L) of the drying surface (4) and are separated from the drying surface (4) by a barrier (18). The sludge turner (3) comprises at least a first and a second wheel (14.1, 14.2) mounted on opposite sides of a common gantry (7) of the sludge turner (3). While the sludge turner (3) is in operation, the first wheel (14.1) rolls on the first travel path (5.1) and the second wheel (14.2) on the travel path (5.1) as the respective travel plane. In the region of the first travel path (5.1), the barrier (18) comprises a first guide (16.1) and a second guide (16.1) in the region of the second travel path (5.2) extending in the direction of travel (F) of the sludge turner (3), wherein the sludge turner (3)—while the latter is traveling—is guided transversely to the direction of travel (F) with the aid of the guides (16.1, 16.2), and wherein the guides (16.1, 16.2) extend upwards from the drying surface (4) and act as a barrier for the sludge (2) spread on the drying surface (4) to keep sludge (2) away from the travel paths (5.1, 5.2).

The present invention relates to a system for drying sludge, in particular sewage sludge generated during wastewater treatment, wherein the system preferably comprises a rectangular drying surface to accommodate the sludge over a flat surface, wherein the system comprises a movable sludge turner adapted to turn, while also mixing, the sludge spread on the drying surface, wherein the system comprises a first travel path and a second travel path, wherein the two travel paths at least partially extend on opposite longitudinal sides of the drying surface and are separated from the drying surface by a barrier, wherein the sludge turner comprises at least one first wheel and at least one second wheel, wherein the wheels are mounted on opposite sides of a common gantry of the sludge turner that spans the drying surface in a transverse direction of the drying surface, and wherein the first wheel rolls on the first travel path and the second wheel rolls on the second travel path as the respective travel plane while the sludge turner is in operation, and a corresponding sludge tuner.

EP 0 680 791 A1 discloses a device for introducing burned lime into a mass of hydrocarbon products, which comprises a rectangular pit into which the mass is introduced and a movable tool that moves above the pit and consists of a combination of a rotary tool and a distribution tool preferably arranged directly before or after the rotary tool. The pit is provided with a travel path on at least one of its long sides and the pit and the travel path are separated by two parapets. The parapets serve to keep the mass in the pit. They can also serve as a guide for the vehicle. Accordingly, the apparatus is used to produce fertilizers by mixing various components. The turning of sewage sludge for uniform and rapid drying of the sewage sludge is not described in this publication. There are also no details provided about how the vehicle is to be guided. The parapets apparently only serve to prevent the wheels from moving into the pit by mistake, similar to a curb.

A sludge treatment system is known from US 2012/0017461 A1, wherein sludge mass is spread on an elongated floor. Parallel guide rails are arranged on the floor in the longitudinal direction and a movable cart is located transversely above a work surface of a floor. The movement of the cart by longitudinal travel over the floor is initiated by a first drive shaft equipped with a gear that meshes with a drive chain. A second chain is used to guide the cart. There is a rotating turning tool on the cart that reaches into the sludge. It consists of pairs of semi-cylindrical scoops, which are substantially symmetrically fastened with one of their edges on both sides of a driven shaft. The movable cart rests with its wheels on the guide rails and relies on the chain drive system to follow the motorized drive above the floor. The sludge treatment system also comprises at least one stabilization system having a carrier and a wheel. The stabilization system cooperates with, and is supported by, the guide rail. In addition, the wheel effects a guide along the guide rail and prevents the moving cart from “traveling out of alignment”. The disadvantage is the complex guide rail, which firstly must accommodate the load of the cart as a rolling surface and secondly must also act as a guide rail for the cart. Parapets are also required on which the guide rails are arranged and which hold the sludge mass on the floor in the area where it can be turned.

The solar sludge-drying machines commercially available until now use a gantry structure, wherein the gantry travels on a travel wall in a clean area undisturbed by sludge. The travel plane for the wheels is above or up to the height of the sludge bed. The travel wall is also used as a dead stop device for the gantry machine. The construction of the travel wall, in particular also a retrofitting of existing systems with a state-of-the-art sludge turner, is time-consuming and cost-intensive due to the construction of the travel wall.

The object of the present invention is therefore to create a system for drying sludge and a sludge turner that can be easily guided and operated without elaborate construction work on the drying surface or the travel path.

The problem is solved by a system for drying sludge and a sludge turner having the features of the independent claims.

The invention proposes a system for drying sludge, in particular sewage sludge generated during wastewater treatment, wherein the system comprises a preferably rectangular drying surface to accommodate the sludge over a flat surface. The system also comprises a moveable sludge turner adapted to turn, while also mixing, the sludge spread on the drying surface, wherein the system comprises a first travel path and a second travel path. The two travel paths extend at least partially on opposite longitudinal sides of the drying surface and are separated from the drying surface by a barrier. The sludge turner comprises at least one first wheel and at least one second wheel, wherein the wheels are mounted on opposite sides of a common gantry of the sludge turner that spans the drying surface in a transverse direction of the drying surface. A turning device, usually a rotating roller with scoops arranged thereon, is arranged in the area of the gantry. The scoops reach into the sludge and turn the sludge such that the regular turning over accelerates the drying process of the sludge. The sludge turner is equipped with a drive and moves along the drying surface on the at least two wheels. When the sludge turner is operated, the first wheel rolls on the first travel path and the second wheel rolls on the second travel paths as the respective travel plane. The at least two wheels support the sludge turner on the travel paths or the travel planes.

In the area of the first travel path, the barrier comprises a first guide extending in a direction of travel of the sludge turner, and in the area of the second travel path comprises a second guide for the sludge turner extending in the direction of travel of the sludge turner. Aided by the guides, the sludge turner is guided transversely to the direction of travel while traveling along the drying surface. This ensures that as the sludge turner travels, the latter remains substantially aligned transverse to the drying surface, constantly scans the drying surface, and is thus able to turn the complete sludge distributed over the drying surface.

The guides extend upwards from the drying surface and serve as a barrier for the sludge spread on the drying surface in order to keep sludge away from the travel paths. The inventive guides have the advantage that they are positioned directly on the drying surface or floor surface of the system. The drying surface can thus be adapted flat, wherein the guides are only positioned onto the drying surface or floor surface. A special, elaborate design of the drying surface to enable guidance for the sludge turner is not required. When building the system, it is therefore sufficient that a very simple drying surface or floor surface is provided onto which the guides for the sludge turner are positioned. This permits a simple, fast, and cost-effective construction of the system. It is also easy to retrofit the sludge turner to an existing drying surface of old systems.

By creating a boundary of the drying surface, the guides also fulfill another task. The guides create a boundary for the drying surface on which the sludge is located in relation to the travel path for the sludge turner. Firstly, this ensures that the sludge remains in the area where it can also be turned, i.e., below the gantry of the sludge turner, where the turning device is located. This avoids parts of the sludge that are not turned because those parts are at rest, or come to rest, outside the area of the turning device of the sludge turner during the turning process. This can result in a uniform and rapid drying of the sludge. Secondly, the guides also ensure that the travel path for the sludge turner remains clean. The guides ensure that sludge cannot get into the area of the travel path and could thus interfere with the movement of the sludge turner along the drying surface. The travel path is therefore not cleaned, or only at long intervals. Maintenance of the system is thus also simplified.

It is advantageous if the guides are each formed by a single or multi-part metal profile that is connected, preferably bolted, to a floor surface, in particular to the floor surface of a solar drying hall or the drying surface. The connection is preferably detachable, so that the guides can be adjusted in their position or also easily dismantled. The metal profile can be mounted on the floor surface of the system and can be adapted to the individual needs and dimensions of the sludge turner. If necessary, subsequent corrections are also possible in order to be able to adjust the position of the guides relative to the sludge turner. The production and assembly of the system for drying sludge can therefore be carried out quickly and cost-effectively. A multi-part profile can be advantageous if several guide surfaces are required to accurately position the sludge turner or if the fastening to the floor requires an individual adaptation to the floor surface and the actual guide surface is to be standardized.

It is advantageous if the metal profile has a substantially L-shaped cross-section. This makes it easy to implement the fastening to the floor with one leg of the L-shaped cross-section and the guiding of the sludge turner with the other leg of the L-shaped cross-section.

It is also advantageous if the floor surface on which the guides are mounted is part of the system and forms the drying surface and/or the travel paths. The drying surface or the travel paths are in a defined, mostly horizontal and flat state such that the guides can also be mounted thereon in a defined manner.

It is advantageous if the drying surface and the travel paths are in the same plane, wherein the plane preferably has a vertically extending normal. The travel paths are therefore arranged below the sludge bed height. The sludge bed height is the maximum height at which the sludge can be arranged above the drying surface such that the gantry can travel over the sludge with the turning device and can completely turn the sludge without accumulating it into a mound.

It is also advantageous if the sludge turner has a first guide roller, by which it contacts the first guide during travel and/or the sludge turner has a second guide roller, by which it contacts the second guide during travel. The guide rollers position the sludge turner transversely to the drying surface and allow a particularly low-friction alignment and ability to move the sludge turner along the sludge bed or the drying surface during its travel.

It is also advantageous if the guide rollers each have an axis of rotation that extends vertically or at an angle to the vertical. The sludge turner is guided accurately with a vertically extending axis of rotation. If the guide rollers are arranged at an angle to the vertical, this ensures a more stable guidance and allows the sludge turner to avoid obstacles and to subsequently return to the ideal position.

In a particularly advantageous embodiment of the invention, the sludge turner has a bulkhead in the region of the first wheel and in the region of the second wheel, each of which overlap in the vertical direction with one of the guides and have a distance to the respective adjacent guide in the horizontal direction, the amount of which is preferably between 1 mm and 30 mm, in particular between 3 mm and 20 mm. The cooperation of the bulkhead and guide prevents sludge from the area of the drying surface, in particular when it is turned, from entering the area of the guide device and the travel surface, and from soiling these or even preventing the operation of the system. The bulkhead is arranged on the sludge turner and is moved along the drying surface and the guides together with the sludge turner. Thus, the protection against dirt buildup is always present in the area where the turning operation could cause sludge to fall out of the intended area of the drying surface.

It is also advantageous if the bulkheads are arranged between the guides in a direction extending transverse to the direction of travel of the sludge turner. This arrangement ensures particularly good protection against dirt buildup on the guide device and the travel paths.

It is also advantageous if respectively one guide extends between a guide roller and a bulkhead. The guide and the bulkhead thus reliably protect the guide roller, which forms the guide device together with the surface of the guide on which the guide roller travels, from contamination.

It is also advantageous if the sludge turner has at least one pusher plate for moving the sludge located on the drying surface. The pusher plate causes the sludge to be largely kept out of the area of the guide device and the travel path. It is arranged on the sludge turner at the ends of the gantry or in the region of the lateral edges of the drying surface and reaches under the sludge in this region and conveys the latter towards the center of the drying surface. As a result, the sludge is securely captured by the turning device of the gantry and can be reliably turned with the remaining sludge. In addition, this ensures that the sludge located in the edge region of the drying surface does not fall in the direction of the guide device and the travel path and soils these.

It is also advantageous if the sludge turner has a motor as a drive that is in particular in operative connection with at least one wheel in order to cause a movement of the sludge turner along the drying surface. The drive acts directly or indirectly on the wheel and drives the wheel and thus the sludge turner.

It is advantageous if the system comprises a traction means, in particular a chain, that is in operative connection with the drive of the sludge turner, wherein an operation of the drive results in a relative movement between the sludge turner and the traction means. The drive motor comprises a gear wheel that for example engages into the stationary chain, in particular a steel link chain, laid out along the drying surface and moves the sludge turner along the chain.

Furthermore, it is advantageous if the system comprises at least one electrical power cable, preferably extending along one of the travel paths, and the sludge turner has a power pickup that is in operative connection with the electrical power cable. The electrical power cable supplies power to the sludge turner such that the turning device and the sludge turner drive can both be operated.

An inventive moveable sludge turner is provided for a system for drying sludge on a drying surface. The sludge turner has at least one first wheel and at least one second wheel, wherein the wheels are mounted on opposite sides of a common gantry of the sludge turner. A turning device of the sludge turner is arranged on the gantry. A barrier for separating the wheels from the drying surface comprises a first guide extending in a direction of travel of the sludge turner and a second guide extending in the direction of travel of the sludge turner. With the aid of the guides, the sludge turner is guided during travel transversely to the direction of travel. The guides extend upwards from a travel plane of the wheels and act as a barrier for the sludge spread on the drying surface in order to keep sludge away from the travel paths. It is therefore not necessary to use the guides as a travel path at the same time. Accordingly, they can be designed more easily and arranged independently of the actual travel path. The sludge turner with the gantry and the wheels as well as the guides form a unit that can be operated on almost any floor. The guides are fastened to the floor and act as linear guides for the sludge turner. The wheels of the sludge turner roll on a travel plane that is also located on the floor, independently of the guides. The sludge turner and the guides can thus be universally mounted in halls intended for sludge drying. Special designs of the hall floor are not required for adaptation to the sludge turner.

It is also advantageous if the sludge turner has at least one guide roller. With the at least one guide roller, the sludge turner can be aligned with the guide and in particular linearly guided.

It is also advantageous if the sludge turner has at least one pusher plate. The pusher plate ensures that the sludge to be turned remains in the area under the turning device in order to be reliably turned and thus dried quickly and evenly. The pusher plate pushes sludge lying on the edge onto the more central drying surface to thus be reliably turned. In addition, the pusher plate is used to prevent sludge from falling on the guides or the travel path.

It is also advantageous if the sludge turner has a bulkhead in the region of the first wheel and in the region of the second wheel. The bulkhead seals the guides and the travel path against the sludge bed and ensures that the guides and the travel path remain largely clean. The bulkhead is moved together with the sludge turner and is arranged on the inside of the sludge turner, directly next to the sludge bed present during operation of the sludge turner.

The system for drying sludge and the sludge turner are adapted according to the above description, wherein the aforementioned features can be present individually or in any combination.

The present invention, in which the travel wall is replaced by a contact angle bracket as a guide, is particularly advantageous, since a contact angle bracket is significantly cheaper than a travel wall. The local construction specifications are also simplified since the contact angle bracket can be adjusted if installed incorrectly. Construction progress is streamlined because the contact angle bracket only needs to be installed directly after concrete is poured on the surface or only after the machinery is delivered. The implementation of the idea also requires a modified gantry structure of the sludge turner. The contact surface of the wheels and thus the location where the wheels are mounted on the machine must be moved down by the height of the former travel wall. In a particularly advantageous embodiment, the machine can push the sludge together. This is for example done with a push carriage or with an adapted sludge turning tool. The travel plane for the wheels is preferably below the sludge bed height or at the level of the surface on which the sludge bed is deposited. The machine is self-propelled, operated with electrical power, and permanently installed.

The new sludge turner no longer travels on structural travel walls, but directly on the ground. Preferably, the travel plane of the sludge turner and the storage surface of the sludge to be turned are at one height, and their turning tool is wider than 8 m, preferably wider than 10 m.

The function of the wall in the prior art, which acts as a guide stop, distributes the weight force, and aggregates the sludge deposit, is now taken over by the machine. It is advantageous if a control is integrated into the machine to compensate for a possible misalignment, corresponding wheels and/or a sludge aggregation mechanism.

In the system according to the invention, the travel plane and the storage surface of the sludge material to be turned are advantageously at one height and are separated by a lateral structure.

The lateral structure with the guides is preferably assembled of individual pieces that are not longer than 3 meters. An expected thermal expansion of the lateral structure or guides occurs in short joints between the individual pieces. This has advantages for the side rollers in order to permit precise guidance of the sludge turner. The lateral structure preferably consists of components that weigh less than 100 kg individually. This allows the system to be set up quickly. For this purpose, each section of the lateral structure is preferably connected a maximum of 3 times to the floor by means of dowels/concrete screws/anchors.

The machine is preferably equipped with cleaning devices, in particular brushes, to clean possible dirt buildup on the travel surface.

The sludge turner has a device, in particular a control unit, which, for example, detects the ACTUAL orientation of the sludge turner from the position of the guide rollers and accordingly controls the drive of the travel wheels at the two ends of the gantry differently. This monitors and prevents misaligned travel or lifting of the machine. The travel wheel construction is therefore adapted such that a parallelism of the travel wheels can be adjusted.

If the end of the track is exceeded, the sludge turner is preferably stopped by an emergency stop signal or a mechanical dead stop.

In a particularly advantageous embodiment of the invention, the sludge turner can be rolled into, or rolled out of, an existing greenhouse. The travel wheels are adapted such that the machine can roll directly onto concrete or asphalt.

Further advantages of the invention are described in the following exemplary embodiments. These shows in

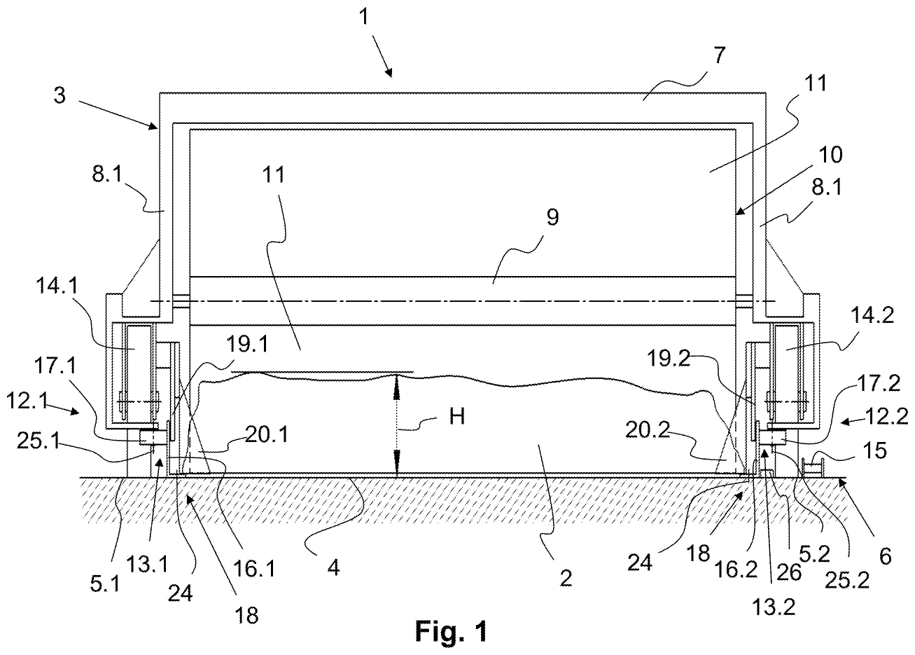

FIG. 1 a front view of a system for drying sludge with a sludge turner,

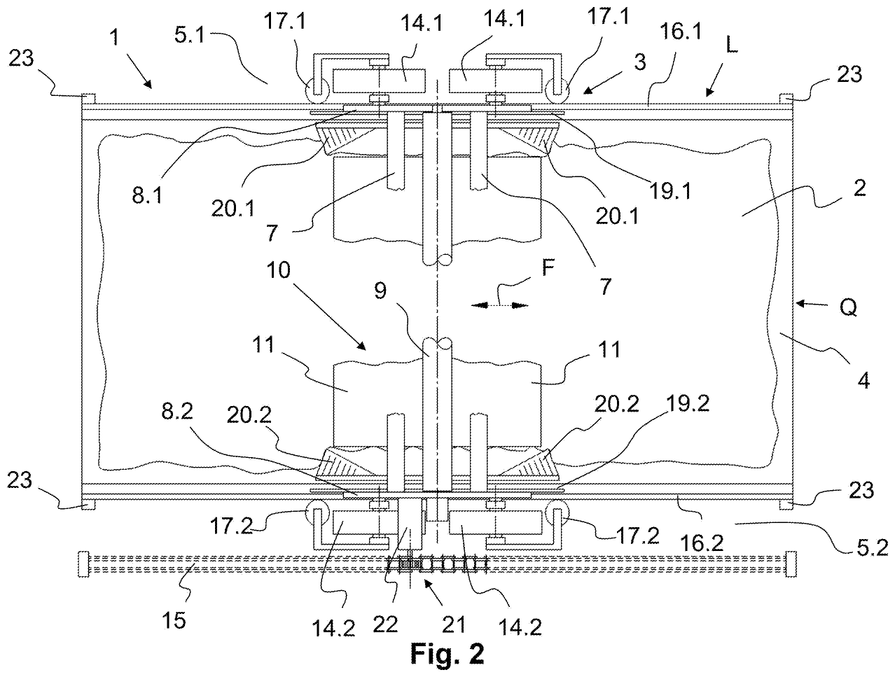

FIG. 2 a top view of a system for drying sludge with a sludge turner, and in

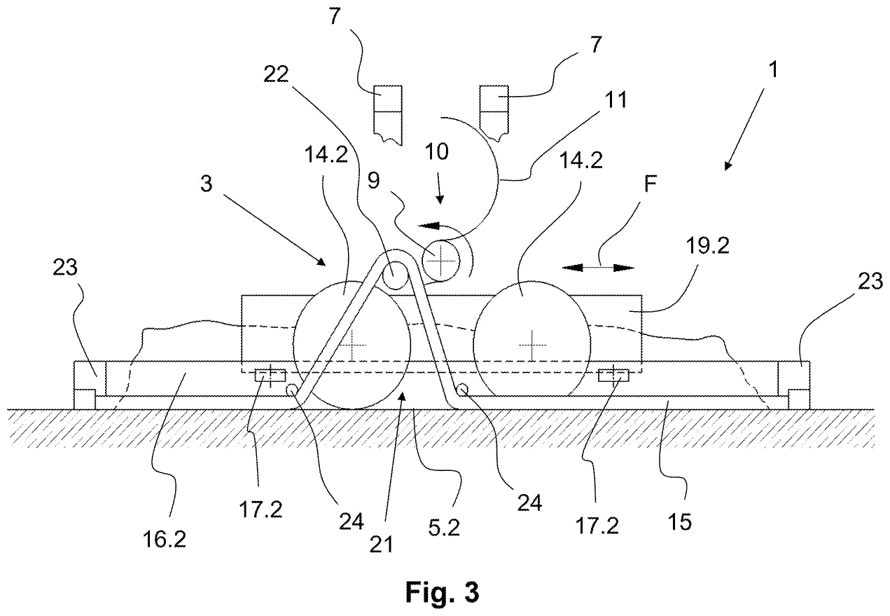

FIG. 3 a side view of a section of a system for drying sludge with a sludge turner.

In the following description of the illustrated design examples, the same reference symbols are used for features that are identical and/or at least comparable in their design and/or mode of action, even if they are shown in different design examples. If these are not explained in detail again, their design and/or mode of action corresponds to the design and mode of action of the features already described above.

FIG. 1 shows a front view of a system 1 for drying sludge 2 with a sludge turner 3. The system 1 is usually arranged in a hall. The sludge 2 rests on a drying surface 4 with a sludge bed height H. Together with two travel paths 5.1 and 5.2, the drying surface 4 forms a floor surface 6 of the system 1. The drying surface 4 and the two travel paths 5.1 and 5.2 are substantially level, in particular at the same height. Thus, it is particularly easy to produce the floor surface 6 of the system 1, since the later travel path 5.1 or 5.2 must not yet be taken into account for the production of the floor area 6.

The sludge turner 3 comprises a gantry 7 fastened between two frames 8.1 and 8.2 of the sludge turner 3. A roller 9 with a turning device 10 is arranged such that it can rotate on the gantry 7 or on the frames 8.1 and 8.2. In this exemplary embodiment, two scoops 11 are located on the roller 9, which alternately reach into and turn the sludge 2 such that it can dry evenly.

A drive device 12.1 and 12.2 and a guide device 13.1 and 13.2 are arranged on each of the frames 8.1 and 8.2. The drive device 12.1 and 12.2 comprises at least one first wheel 14.1 and one second wheel 14.2. The wheel 14.1 or 14.2 rolls on the travel path 5.1 or 5.2, which form the travel plane for wheels 14.1, 14.2. At least one of the drive devices 12.1 and 12.2, in this case the drive device 12.2, further comprises a chain 15 as a traction means, into which, as will be described in greater detail below, a motor drive of the sludge turner 3 engages and moves the sludge turner 3 on the travel paths 5.1 or 5.2 along the drying surface 4. Electrical power for operating the sludge turner 3 can be supplied by an electrical power cable 26.

One of the guide devices 13.1 and 13.2 is arranged on both sides of the drying surface 4. Each of the guide devices 13.1 and 13.2 comprises an L-shaped guide 16.1 or 16.2, preferably adapted as a metal profile that is bolted to the floor surface 6 with screws 24. At least one guide roller 17.1 or 17.2 respectively cooperates with the guide 16.1 or 16.2 by making contact to the guide 16.1 or 16.2 and by determining the position of the sludge turner 3 in relation to the drying surface 4. In this exemplary embodiment, an axis of rotation 25.1 or 25.2 of the guide roller 17.1 or 17.2 is vertically oriented. However, it can also be oriented at an incline in relation to the floor surface 6, either alone or together with the guide 16.1 or 16.2. The guide roller 17.1 or 17.2 can cooperate with a not shown control system, which influences the at least one drive device 12.1 or 12.2 and ensures that the sludge turner 3 moves as accurately as possible transverse to the drying surface 4. For example, not shown sensors can be used for this purpose, which determine the contact pressure of the guide rollers 17.1 or 17.2 on the guides 16.1 or 16.2 and forward this information to the control unit.

The guide 16.1 or 16.2 forms a barrier 18 between the drying surface 4 and the travel paths 5.1 or 5.2. The barrier 18 ensures that sludge 2 cannot fall from the drying surface 4 onto the travel path 5.1 or 5.2 and soil the latter. A bulkhead 19.1 or 19.2 is provided to ensure that sludge cannot fall onto the travel path 5.1 or 5.2, even at a sludge bed height H that is higher than the guide 16.1 or 16.2. The bulkhead 19.1 or 19.2 is attached to frame 8.1 or 8.2 and travels along the drying surface 4 together with the sludge turner 3. The bulkhead 19.1 or 19.2 is higher than the maximum sludge bed height H, is separated from the guide 16.1 or 16.2 by only a few millimeters, and overlaps the guide 16.1 or 16.2. Together with the guide 16.1 or 16.2, the bulkhead 19.1 or 19.2 thus reliably protects the travel paths 5.1 or 5.2 against dirt buildup.

Pusher plates 20.1 and 20.2 are arranged on the side of frames 8.1 and 8.2 facing the sludge 2. The pusher plates 20.1 and 20.2 ensure that sludge 2 remains on the drying surface 4 and does not fall onto the travel paths 5.1 and 5.2. Sludge 2 that reaches the edge area of the drying surface 4 during the turning operation is moved back into a central area of the drying surface 4 by the pusher plates 20.1 and 20.2.

FIG. 2 shows a top view of the system 1 for drying sludge 2 with the sludge turner 3. This view shows that the gantry 7 of the sludge turner 3 comprises two bars extending in parallel that are attached to the two frames 8.1 and 8.2. The gantry 7 thus bridges the lateral side of the drying surface 4 on which the sludge 2 is deposited.

The turning device 10, which comprises the roller 9 as well as two scoops 11, is also arranged on the frames 8.1 and 8.2. The pusher plates 20.1 and 20.2 are provided so that the sludge 2 remains in the area of the scoops 11 and can be turned completely and also to ensure that the sludge 2 does not fall into the area of the travel paths 5.1 or 5.2. Since the sludge turner 3 is provided for a direction of travel F in both directions along a longitudinal side L of the drying surface 4, pusher plates 20.1 and 20.2 for each of the directions of travel F are advantageous.

The guides 16.1 and 16.2 are provided for the lateral boundary of the drying surface 4. The guides 16.1 and 16.2 cooperate with the bulkheads 19.1 and 19.2, which are arranged so close to the guides 16.1 and 16.2 at a distance of only a few millimeters such that sludge 2 is prevented from falling onto the travel paths 5.1 and 5.2 when being turned by the turning device 10. The bulkheads 19.1 and 19.2 travel together with the sludge turner 3, thus causing the bulkhead to always be at the point where the risk that sludge 2 could fall onto the travel paths 5.1 or 5.2 is greatest.

The wheels 14.1 and 14.2 as well as the guide rollers 17.1 and 17.2 are also arranged on the frames 8.1 and 8.2. On each travel path 5.1 and 5.2, the sludge turner 3 comprises two of the wheels 14.1 and 14.2 and guide rollers 17.1 and 17.2 respectively. This achieves a stable positioning and travel of the sludge turner 3. The guide rollers 17.1 and 17.2 are supported on the guides 16.1 or 16.2 such that the sludge turner 3 is always aligned substantially transversely to the drying surface 4. They can cooperate with a not shown control system, which, when the sludge turner 3 is misaligned in relation to the transverse direction Q of the drying surface 4, commands a compensation in the drive of the slurry turner 3 such that the alignment is corrected accordingly.

The sludge turner 3 is moved with a drive 21, which comprises a motor 22 arranged on the frame 8.1. The motor 22 engages into the chain 15, which serves as a traction means. The sludge turner 3 is thereby moved along the chain 15. The direction of rotation of the motor 22 is changed to reverse the direction of travel. The chain 15 is arranged stationary next to the travel path 5.1. However, it would also be possible to provide a second drive 21 with a second chain 15 on the opposite side, outside of the travel path 5.2.

In order to prevent the sludge turner 3 from traveling beyond the drying surface 4, a mechanical or electrical dead stop 23 is provided at the end of the drying surface 4 or the travel paths 5.1 and 5.2. As soon as the sludge turner 3 reaches the dead stop 23, it either stops or changes its direction of travel F.

FIG. 3 shows a side view of a section of the system 1 for drying sludge 2 with the sludge turner 3. FIG. 3 shows that the gantry 7 is arranged such that the scoops 11 of the turning device 10 can rotate with the roller 9 below the gantry 7. The bulkhead 19.2 overlaps the guide 16.2 in vertical direction by several, preferably more than 2, centimeters, such that the area on the drying surface 4 and the travel path 5.2 is partitioned off in the area of the turning device 10. The two wheels 14.2 roll on the travel path 5.2 as a rolling surface. The drive 21 comprises the motor 22, which engages into the chain 15. The chain 15 is laid out stationary next to the travel path 5.2; however, it is raised from the travel path 5.2 in front of and behind the motor 22 with deflections and guided up to the motor 22. By rotating a shaft with a drive wheel of the motor 22, the sludge turner 3 is moved in the direction of travel F. The deadstop 23, which stops the travel of the sludge turner 3, is arranged in each case at the end regions of the guide 16.2.

Other types of drives of the sludge turner 3 are of course also possible. For example, a direct drive of the wheels 14.1 or 14.2 can be implemented with one motor each. It is also possible for the turning device 10 to be adapted differently than with the scoops 11 shown here. It is essential that the sludge 2 is turned evenly.

The present invention is not limited to the illustrated and described exemplary embodiments. Modifications within the scope of the claims are also possible as well as a combination of the features, even if they are shown and described in different exemplary embodiments.

### LIST OF REFERENCE SYMBOLS

1 System
2 Sludge
3 Sludge turner
4 Drying surface
5 Travel path
6 Floor surface
7 Gantry
8 Frame
9 Roller
10 Turning device
11 Scoop
12 Drive device
13 Guide device
14 Wheel
15 Chain
16 Guide
17 Guide roller
18 Barrier
19 Bulkhead
20 Pusher plate
21 Drive
22 Motor
23 Dead stop
24 Screw
25 Axis of rotation
26 Electrical power cable
L Longitudinal side
H Sludge bed height
F Direction of travel
Q Transverse direction

1. A system for drying sludge (2), in particular sewage sludge generated during wastewater treatment,
wherein the system comprises a, preferably rectangular, drying surface (4) for accommodating the sludge (2) over a flat area,
wherein the system (1) comprises a movable sludge turner (3) adapted to turn and mix the sludge (2) spread on the drying surface (4),
wherein the system has a first travel path (5.1) and a second travel path (5.2), wherein the two travel paths (5.1, 5.2) extend at least partially on opposing longitudinal sides (L) of the drying surface (4) and are separated from the drying surface (4) by a barrier (18),
wherein the sludge turner (3) has at least one first wheel (14.1) and at least one second wheel (14.2), wherein the wheels (14.1, 14.2) are supported on opposite sides of a common gantry (7) of the sludge turner (3), which spans the drying surface (4) in a transverse direction (Q) of the drying surface (4), and
wherein the first wheel (14.1) rolls on the first travel path (5.1) and the second wheel (14.2) rolls on the second travel path (5.1) as the respective travel plane when the sludge turner (3) is in operation,
characterized in that
the barrier (18) in the area of the first travel path (5.1) comprises a first guide (16.1) and a second guide (16.1) in the area of the second travel path (5.2) extending in the direction of travel (F) of the sludge turner (3), wherein the sludge turner (3)—as the latter travels—is guided transversely to the direction of travel (F) with the aid of the guides (16.1, 16.2), and wherein the guides (16.1, 16.2) extend upwards from the drying surface (4) and act as a barrier for the sludge (2) spread on the drying surface (4), to keep sludge (2) away from the travel paths (5.1, 5.2).

2. The system according to claim 1, characterized in that the guides (16.1, 16.2) are each formed by a single or multi-part metal profile that is connected, preferably bolted, to a floor surface (6), in particular to the floor surface (6) of a solar drying hall.

3. The system according to claim 2, characterized in that the metal profile has an essentially L-shaped cross-section.

4. The system according to claim 2, characterized in that the floor surface (6) is part of the system (1) and forms the drying surface (4) and/or the travel paths (5.1, 5.2).

5. The system according to claim 1, characterized in that the drying surface (4) and the travel paths (5.1, 5.2) are on the same plane, wherein the plane preferably has a vertically extending normal.

6. The system according to claim 1, characterized in that the sludge turner (3) comprises a first guide roller (17.1), by which the sludge turner (3) contacts the first guide (16.1) while traveling and/or the sludge turner (3) comprises a second guide roller (17.2), by which the sludge turner (3) contacts the second guide (16.2) while traveling.

7. The system according to claim 6, characterized in that the axis of rotation (25) of each of the guide rollers (17.1, 17.2) extends vertically or at an angle to the vertical.

8. The system according to claim 6, characterized in that the sludge turner (3) in the region of the first wheel (14.1) and in the region of the second wheel (14.2) respectively has a bulkhead (19.1, 19.2), which in vertical direction respectively overlap with one of the guides (16.1, 16.2) and in horizontal direction has a distance to the respectively adjacent guide (16.1, 16.2), the amount of which is preferably between 1 mm and 30 mm, in particular between 3 mm and 20 mm.

9. The system according to claim 8, characterized in that the bulkheads (19.1, 19.2) are arranged between the guides (16.1, 16.2) in a direction extending transverse to the direction of travel (F) of the sludge turner (3).

10. The system according to claim 8, characterized in that respectively one guide (16.1, 16.2) extends between a guide roller (17.1, 17.2) and a bulkhead (19.1, 19.2).

11. The system according to claim 1, characterized in that the sludge turner (3) comprises at least one pusher plate (20) for moving the sludge (2) located on the drying surface (4).

12. The system according to claim 11, characterized in that the sludge turner (3) comprises a drive (21) that is in particular in operative connection with at least one wheel (14.1, 14.2) in order to cause a movement of the sludge turner (3).

13. The system according to claim 12, characterized in that the system (1) comprises a traction means that is in operative connection with the drive (21) of the sludge turner (3), wherein an operation of the drive (21) results in a relative movement between the sludge turner (3) and the traction means.

14. The system according to claim 1, characterized in that the system comprises at least one electrical power cable (26), preferably extending along one of the travel paths (5.1, 5.2), and in that the sludge turner (3) comprises a power pickup that is in operative connection with the electrical power cable (26).

15. A movable sludge turner for a system (1) for drying sludge (2) on a drying surface (4) according to claim 1, wherein the sludge turner (3) has at least one first wheel (14.1) and at least one second wheel (14.2), wherein the wheels (14.1, 14.2) are supported on opposite sides of a common gantry (7) of the sludge turner (3), characterized in that a barrier (18) for separating the wheels (14.1, 14.2) from the drying surface (4) comprises a first guide (16.1) and a second guide (16.2) extending in the direction of travel (F) of the sludge turner (3), wherein the sludge turner (3)—while the latter is traveling—is guided transversely to the direction of travel (F) with the aid of the guides (16.1, 16.2), and wherein the guides (16.1, 16.2) extend upwards from a travel plane of the wheels (14.1, 14.2) and act as a barrier for the sludge (2) spread on the drying surface (4) to keep sludge (2) away from the travel paths (5.1, 5.2).

16. The sludge turner (3) according to claim 15, characterized in that the sludge turner (3) comprises at least one guide roller (17.1, 17.2).

17. The sludge turner (3) according to claim 15, characterized in that the sludge turner (3) comprises at least one pusher plate (20).

18. The sludge turner (3) according to claim 15, characterized in that the sludge turner (3) comprises a bulkhead (19) in the region of the first wheel (14.1) and in the region of the second wheel (14.2).
